(19) United States
(12) Patent Application Publication
(10) Pub. No.: US 2024/0344538 A1
(43) Pub. Date: Oct. 17, 2024

(54) SPRING-ASSISTED LINEAR DRIVE

(71) Applicant: BRAEUER SYSTEMTECHNIK GMBH, ANNABERG-BUCHHOLZ (DE)

(72) Inventor: JENS NITZ, SEHMATAL-SEHMA (DE)

(73) Assignee: BRAEUER SYSTEMTECHNIK GMBH, ANNABERG-BUCHHOLZ (DE)

(21) Appl. No.: 18/291,580

(22) PCT Filed: Aug. 10, 2021
(86) PCT No.: PCT/EP2021/072258

§ 371 Date: Jan. 24, 2024

(51) Int. Cl. F15B 15/22; F15B 15/14

(52) U.S. Cl. CPC F15B 15/226; F15B 15/1457

(57) ABSTRACT

A double-acting linear actuator includes a linear actuator, a receiving disk, a spring, and a piston rod having a piston rod extension fixed to the receiving disk. The spring's first end is supported on the linear actuator and it's second end is supported on the receiving disk. The spring is tensioned by a displacement of the piston rod extension when a pressure is applied to a side of the piston rod. A linear movement is triggered at a force transmission element with a maximum system force when a pressure is applied to a piston side of the linear actuator so that the spring is tensioned and presses against the receiving disk to thereby introduce a stored force of the spring, via the receiving disk being firmly connected to the piston rod extension, into the force transmission element in addition to a force of the linear actuator.

### CROSS REFERENCE TO PRIOR APPLICATIONS

This application is a U.S. National Phase application under 35 U.S.C. § 371 of International Application No. PCT/EP2021/072258, filed on Aug. 10, 2021. The International Application was published in German on Feb. 16, 2023 as WO 2023/016631 A1 under PCT Article 21(2).

### FIELD

The present invention relates to a linear actuator that can be used in all technical areas, but which can in particular be used for cap changing systems.

### BACKGROUND

Such cap changing systems include devices for removing electrode caps from welding electrode shafts, in particular for welding guns in automated systems.

The cap changing systems are arranged for this purpose so that welding robots can reach the welding guns assigned to them with the cap changing system and the electrode caps are brought into engagement with the respective installed cap changing system.

These cap changing systems are regularly formed from a tool carrier with at least one interchangeable head tool mounted therein so as to rotate about a tool rotation axis and a drive for the interchangeable head tool.

Due to the use of such devices, there exist complex requirements for minimizing the size and mass of the linear actuators for such devices.

The use of linear actuators (mechanical/pneumatic/hydraulic) is well known in the prior art.

The same applies to the combination of a linear actuator and a spring for one-sided systems in order to achieve a predefined position or in the form of damping systems.

In pneumatics and hydraulics, for example, the maximum achievable force on the piston rod depends on the diameter of the piston surface that can be pressurized and the available medium pressure.

Technical applications in practice often require a higher force on one side of the piston rod. The choice of setup, whether mounted on the piston crown or on the piston rod side, achieves a technically limited optimization in this respect.

A further increase in the force acting on the piston rod is only possible by adjusting the dimensions (piston diameter and thus the size of the linear actuator) or by increasing the system pressure in the supply unit.

DE 198 25 770 C2 describes a device for fitting electrode caps in which a slide-on device is arranged on the side of the electrode cap magazine opposite the dispensing opening and consists of a cylinder-piston unit that is driven pneumatically or hydraulically. A variant of this solution simply resets the piston using a spring force.

The disadvantage of the solutions known from the prior art is that a greater force is only possible by increasing the piston diameter and thus the size of the linear actuator or by increasing the system pressure in the supply unit.

### SUMMARY

An aspect of the present invention is to achieve a greater force effect with almost the same size of linear actuator.

In an embodiment, the present invention provides a double-acting linear actuator which includes a linear actuator, a receiving disk, a spring having a first end and a second end which is opposite to the first end, and a piston rod which comprises a piston rod extension which is firmly connected to the receiving disk. The spring is supported with its first end on the linear actuator and with its second end on the receiving disk. The piston rod is dimensioned so that it accommodates the spring and a spring travel of the spring. The spring is tensioned by a displacement of the piston rod extension when a pressure is applied to a side of the piston rod. A linear movement is triggered at a force transmission element with a maximum system force when a pressure is applied to a piston side of the linear actuator so that the spring is tensioned and presses against the receiving disk so as to introduce a stored force of the spring, via the receiving disk being firmly connected to the piston rod extension, into the force transmission element in addition to a force of the linear actuator.

### BRIEF DESCRIPTION OF THE DRAWINGS

The present invention is described in greater detail below on the basis of embodiments and of the drawings in which:

FIG. 1 shows such an exemplary pneumatic cap changer;

FIG. 2 shows an exploded view of a pneumatic cap changer with a spring-supported linear actuator;

FIG. 3 shows a pneumatic cap changer in a sectional view with a view of the spring-supported linear actuator;

FIG. 4 shows a pneumatic cap changer with a spring accumulator in the unloaded state in the rest position; and

FIG. 5 shows a pneumatic cap changer with a spring mechanism in a loaded state and open interchangeable head tools.

### DETAILED DESCRIPTION

The present invention provides a combination of a linear actuator (mechanical/pneumatic/hydraulic) with a spring for the purpose of a one-sided force amplification of the linear actuator that goes beyond the pure nominal force of the combination.

According to the present invention, the combination of an externally positioned spring system with a double-acting (in both directions) linear actuator achieves a force amplification on one side without changing the linear actuator dimensioning or the system pressure in the supply unit in a user-specific manner via the nominal force of the linear actuator.

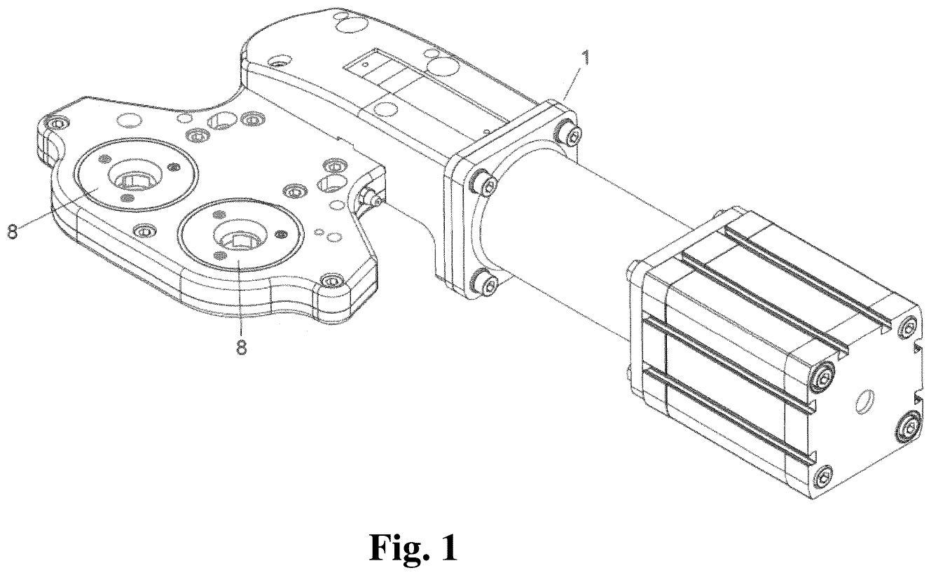

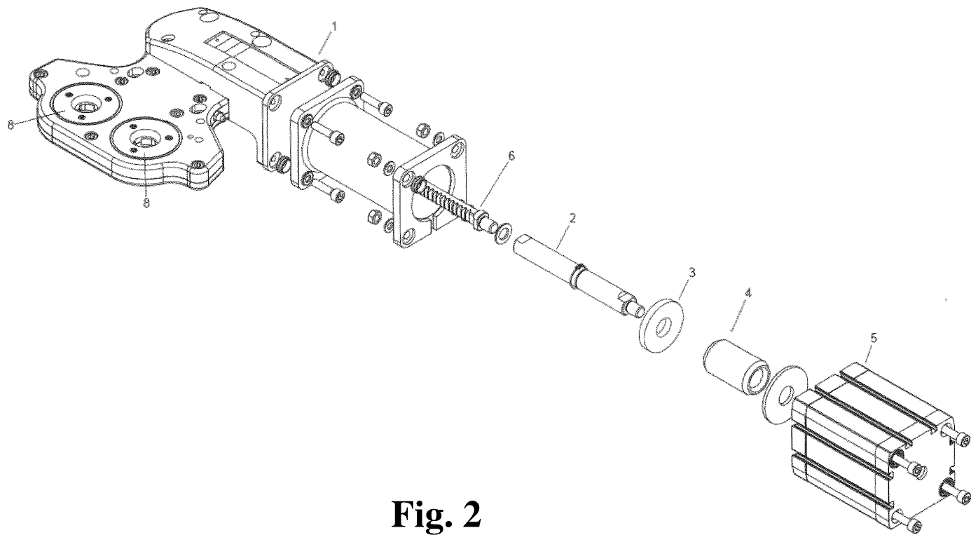

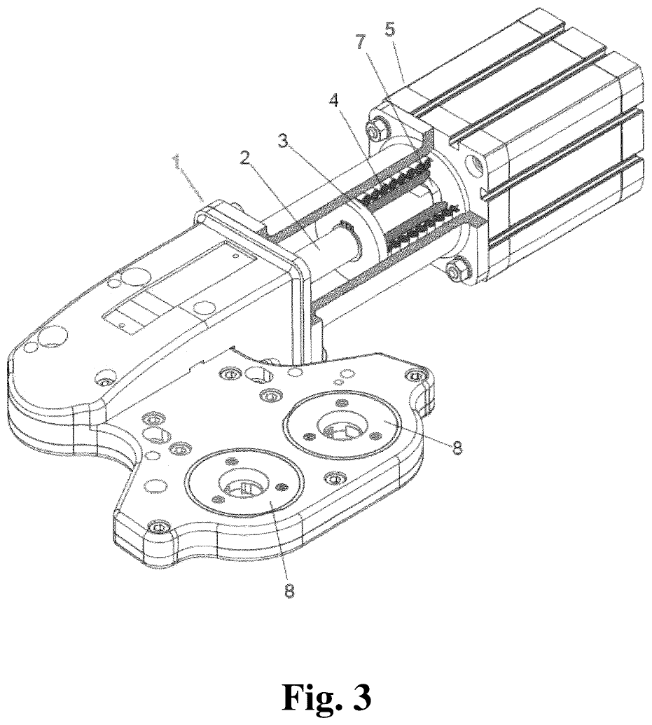

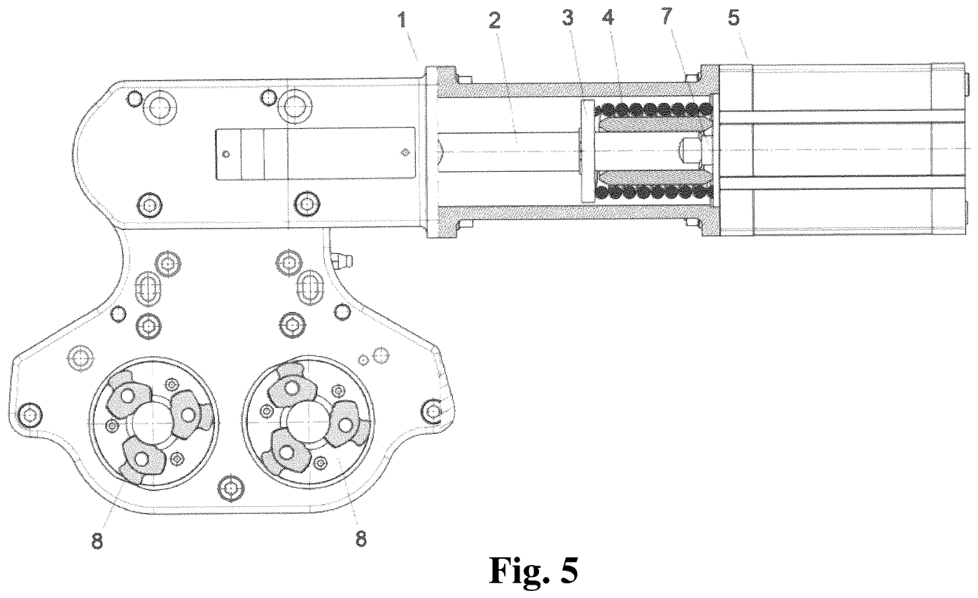

The present invention will be explained in greater detail below based on an exemplary embodiment using a cap changer and FIGS. 1 to 5.

The use of the solutions of a spring-supported linear actuator 5 according to the present invention is also possible in other applications.

For this purpose, a piston rod 7 of the linear actuator 5, which is connected to a gear rack 6 as a force transmission element, is equipped with a piston rod extension 2, which is dimensioned so that it accommodates an additional spring 4 and its corresponding spring travel.

One end of the spring 4 is supported on the linear actuator 5, while the other end is supported on a receiving disk 3, which is firmly connected to the piston rod extension 2.

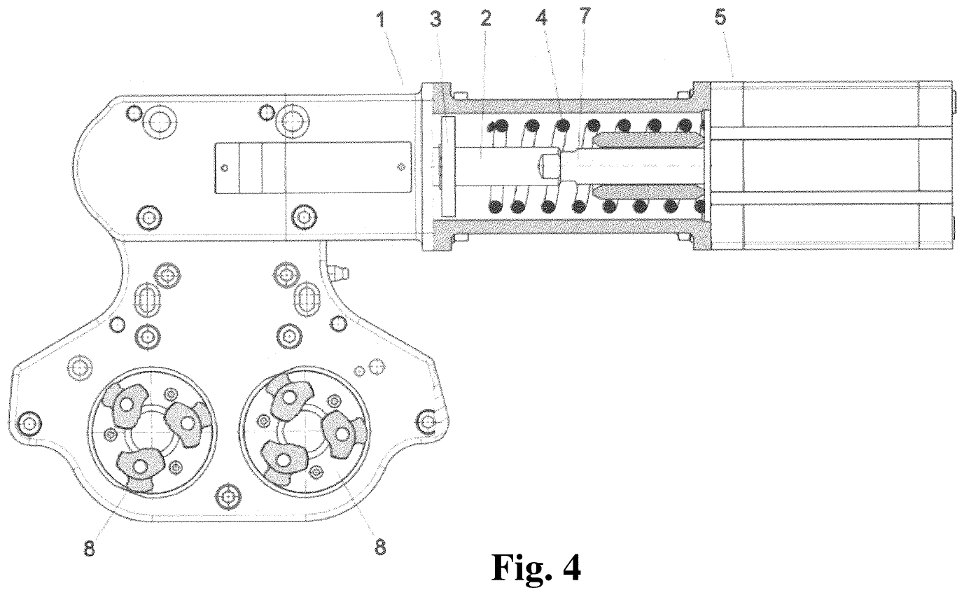

FIG. 4 shows the initial position of the pneumatic cap changer 1 at rest.

A pneumatic cylinder is provided as the linear actuator 5 is in its extended end position, the spring 4 is relaxed, and interchangeable head tools 8 are closed.

To start a cap change process, the interchangeable head tools 8 must be opened. This is performed by pressurizing the pneumatic cylinder as the linear actuator 5 with compressed air on the side of the piston rod 7. The interchangeable head tools 8 are opened via gear rack 6 and connected gear wheels. The receiving disk 3 connected to the piston rod extension 2 at a defined position causes the spring 4 to be loaded.

The force generated on the piston rod side by the pneumatic cylinder as the linear actuator 5 must be greater than the nominal force of the spring 4 in order to be able to fully load it.

The dimensioning of the spring-supported linear actuator 5 depends on the force required on the tool, in this exemplary application, on the torque required on the interchangeable head tool 8, to be able to detach an electrode cap from the cone of the welding gun.

The required system force [Fsystem] which must be applied to the gear rack 6 of the pneumatic cap changer 1 in order to be able to generate the required torque on the interchangeable head tools 8 via the spur gear, is calculated in simplified form as follows:

$$Fsystem ( s ) = Fcylinder + Fspring ( s ) .$$

The pneumatic cylinder is usually dimensioned as a linear actuator 5 depending on the available air pressure, piston diameter, and required stroke length.

It should be noted that the support provided by the spring force is linearly dependent on the spring preload's loading path(s) in accordance with its spring constant. In the unloaded state of the spring L0 (s=0 mm), the support is equal to 0.

$$Fspring ( sL 0 ) = 0 , Fsystem ( sL 0 ) = Fcylinder + 0.$$

In the maximum permissible loaded state of the spring at Ln (smallest length of the spring) or at the largest loading path sn, the support provided by the spring 4 is at its maximum.

$$Fspring ( sn ) = maximum , Fsystem ( sn ) = Fcylinder + Fspring ( sn ) = maximum .$$

With the interchangeable head tools 8 open, the pneumatic cap changer is positioned over the cap to be released so that it is coaxial in the interchangeable head tool 8.

When compressed air is applied to the piston side of the pneumatic cylinder as the linear actuator 5, the linear movement on the gear rack starts with maximum system force (Fsystem (sn)=Fcylinder+Fspring (sn)=maximum).

The loaded spring 4 presses against the receiving disk 3, which, via its fixation with the piston rod extension 2, transfers the stored force of the spring 4 to the gear rack 6 as a linear actuator 5 in addition to the force of the pneumatic cylinder. The interchangeable head tools 8 close and grip the cap to be released. In addition to the force of the spring 4, the increased mass impulse when the interchangeable head tool 8 hits the cap, which is still firmly seated on the cone, during closing also supports the release effect.

The actual system force acting on the gear rack 6/torque on the interchangeable head tool 8 is linearly dependent on the length of the loading path(s) of the spring preload.

In the specific exemplary application, an increase in system force of 78% was determined, based on the nominal force of a pneumatic cylinder with a piston diameter of 63 mm as a linear actuator, at a system pressure p=6 bar and a maximum loading travel of the spring sn=49.31 mm.
Fspring (sn=49.31 mm)=1454.42 N
Fcylinder=1870 N
Fsystem (sn=49.31 mm)=3324.42 N

When the interchangeable head tool 8 hits the cap to be released at s=42 mm, an increase in system force of 59% was determined in relation to the nominal force of the pneumatic cylinder as the linear actuator 5 at p=6 bar.
Fspring (s=42 mm)=1110.648 N
Fcylinder=1870 N
Fsystem (s=42 mm)=2980.648 N

All known systems that achieve equivalent effects with the same support of a linear actuator are to be considered as springs.

The present invention is not limited to embodiments described herein; reference should be had to the appended claims.

### LIST OF REFERENCE NUMERALS

1 Pneumatic cap changer
2 Piston rod extension
3 Receiving disk
4 Spring
5 Linear actuator
6 Gear rack
7 Piston rod
8 Interchangeable head tools

What is claimed is:

1-2. (canceled)

3. A double-acting linear actuator comprising:
a linear actuator;
a receiving disk;
a spring having a first end and a second end, the first end being opposite to the second end, the spring being supported with its first end on the linear actuator and with its second end on the receiving disk; and
a piston rod which comprises a piston rod extension which is firmly connected to the receiving disk, the piston rod being dimensioned so that it accommodates the spring and a spring travel of the spring,
wherein,
the spring is tensioned by a displacement of the piston rod extension when a pressure is applied to a side of the piston rod, and
a linear movement is triggered at a force transmission element with a maximum system force when a pressure is applied to a piston side of the linear actuator so that the spring is tensioned and presses against the receiving disk so as to introduce a stored force of the spring, via the receiving disk being firmly connected to the piston rod extension, into the force transmission element in addition to a force of the linear actuator.

4. The double-acting linear actuator as recited in claim 3, where in the force transmission element is a gear rack.
